(19) United States
(12) Patent Application Publication
(10) Pub. No.: US 2016/0320984 A1
(43) Pub. Date: Nov. 3, 2016

(54) INFORMATION PROCESSING DEVICE, PARALLEL PROCESSING PROGRAM AND METHOD FOR ACCESSING SHARED MEMORY

(71) Applicant: FUJITSU LIMITED, Kawasaki-shi (JP)

(72) Inventors: Yuto Tamura, Kawasaki (JP); Kohta Nakashima, Kawasaki (JP)

(73) Assignee: FUJITSU LIMITED, Kawasaki-shi (JP)

(21) Appl. No.: 15/072,423

(22) Filed: Mar. 17, 2016

(30) Foreign Application Priority Data
Apr. 28, 2015 (JP) 2015-091361

(51) Int. Cl. G06F 3/06; G06F 9/48

(52) U.S. Cl. CPC G06F 3/0617; G06F 3/0659; G06F 3/0673; G06F 9/4881

(57) ABSTRACT

An information processing device includes a storage unit, and a processing unit which carries out one or more threads, and wherein the processing unit judges whether or not a plurality of threads, which access the shared memory area, is carried out when executing an access processing to the shared memory area, carries out the access processing based on a first exclusive control which waits a start of the access processing by another thread during an execution of the access processing by one thread, when judging that single thread is carried out, and carries out the access processing based on a second exclusive control which cancels the access processing by one thread in case that a write for the shared memory area by another thread occurs during an execution of the access processing by one thread, when judging that the plurality of threads are carried out.

### CROSS-REFERENCE TO RELATED APPLICATION

This application is based upon and claims the benefit of priority of the prior Japanese Patent Application No. 2015-091361, filed on Apr. 28, 2015, the entire contents of which are incorporated herein by reference.

### FIELD

The embodiments discussed herein are related to an information processing device, a parallel processing program and a method for accessing shared memory.

### BACKGROUND

The information processing device performing parallel computation includes a function of the exclusive control to maintain the consistency of the data of the shared memory domain where a plurality of threads access.

While as a method of the exclusive control, there is a method that other processors wait by a start of the access processing to a shared memory during an access operation of one thread to a shared memory (below called as a lock method). For example, each thread judges whether or not is able to access the shared memory domain with reference to the variable indicating the exclusion state of the shared memory domain.

On the other hand, there is a method of the exclusive control (below called as HTM method) using the hardware transaction memory (called as HTM) of which the processor of the information processing device includes. The mechanism of HTM guarantees that sequence of instructions (below called as target routine) that a user appointed is carried out as an atomic transaction, for the processing that other threads carry out. When competition of the memory access with other threads occurs during the execution of the target routine, the HTM carries out rollback of the execution of the target routine. For example, the technique about the HTM is listed in following patent documents 1-3.

The user selects a method of the exclusive control to adopt for a program among the lock method and the HTM method at the time of the creation of the program.

### CITATION LIST

### Patent Document

[Patent document 1] Japanese National Publication of International Patent Application No. 2013-513888.

[Patent document 2] Japanese National Publication of International Patent Application No. 2013-520753.

[Patent document 3] Japanese Laid-open Patent Publication No. 2012-128628.

However, in the case that the number of threads, which access a shared memory, is single, the processing time of the program based on the exclusive control of the HTM method may become longer than a program based on the exclusive control of the lock method. The number of threads carrying out changes depending on the processing of program. Therefore, at the time of the creation of the program, it is not easy to select a method of the exclusive control to adopt for a program appropriately.

### SUMMARY

According to an aspect of the embodiments, an information processing device includes a storage unit having a shared memory area, and a processing unit which carries out one or more threads, and
wherein the processing unit judges whether or not a plurality of threads, which access the shared memory area, is carried out when executing an access processing to the shared memory area by the thread, carries out the access processing to the shared memory area based on a first exclusive control which waits a start of the access processing to the shared memory area by another thread during an execution of the access processing to the shared memory area by one thread, when judging that single thread among the plurality of threads is carried out, and carries out the access processing to the shared memory area based on a second exclusive control which cancels the access processing by one thread in case that a write for the shared memory area by another thread occurs during an execution of the access processing to the shared memory area by one thread, when judging that the plurality of threads are carried out.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a diagram explaining the exclusive control of the lock method.

FIG. 2 is a diagram explaining the exclusive control of the HTM method when the conflict does not occur.

FIG. 3 is a diagram explaining the exclusive control based on the HTM method when the conflict occurs.

FIG. 4 is a diagram indicating the performance of the memory access processing when the number of the threads carrying out to access the same shared memory domain is two.

FIG. 5 is a diagram indicating the performance of the memory access processing when the number of the threads which is carried out to access the same shared memory domain is single.

FIG. 6 is a diagram explaining a change of the number of the threads at the time of the execution of the program schematically.

FIG. 7 is a diagram explaining a summary of the processing of the information processing device according to the embodiment.

FIG. 8 is a diagram of hardware constitution of information processing device 100 according to the embodiment.

FIG. 9 is a software block diagram of the information processing device 100 indicated in FIG. 8.

FIG. 10 is a diagram explaining the acquisition processing of the number of the threads, which is memorized in the number of the simultaneous running threads storage area 170 (FIG. 9), carrying out accessing to the same shared memory domain “Sm”.

FIG. 11 is a flow chart diagram explaining a flow of the processing of exclusive control program 133 in the information processing device 100 according to the embodiment.

FIG. 12 is a diagram explaining the change of the exclusive control method schematically.

FIG. 13 is a diagram indicating the performance of the memory access processing based on the exclusive control method according to the embodiment when the number of threads “th” carrying out accessing the same shared memory domain “Sm” is two.

FIG. 14 is a diagram indicating the performance of the memory access processing based on the exclusive control method according to the embodiment, when the number of threads “th” carrying out accessing the same shared memory domain “Sm” is single.

FIG. 15 is a diagram indicating an example of some program pr1 of the application program 132 represented by FIG. 8.

FIG. 16 is a diagram indicating an example of the program pr2 of the exclusion acquisition module 141 represented by FIG. 9 and FIG. 11.

FIG. 17 is a diagram indicating an example of program pr3 of the exclusion release module 151 represented by FIG. 9 and FIG. 11.

FIG. 18A and FIG. 18B are diagrams of flow chart explaining flows of the processing of exclusion acquisition module 142 of the HTM method and the exclusion release module 152 of the HTM method.

FIG. 19A and FIG. 19B are diagrams of flow charts explaining flows of the processing of exclusion acquisition module 143 of the lock method and exclusion release module 153 of the lock method.

### DESCRIPTION OF EMBODIMENTS

Hereinafter, embodiments will be described according to figures. But the technical range in the invention are not limited to the embodiments, are extended the subject matters disclosed in claims and its equivalents.

In an information processing device performing parallel computation, when a plurality of threads access a common resource at the same time, inconsistency of the common resource may occur. The exclusive control means to control to inhibit that the plurality of threads access the common resource at the same time. It is possible to avoid that the inconsistency of the common resource occurs by performing the exclusive control.

The thread indicates the smallest execution unit which works program on an operation system. An information processing device according to the embodiment is a processing device realizing multi-thread processing to carry out the plurality of threads at the same time. The common resource according to the embodiment is a shared memory domain that the plurality of threads is accessible and is a domain of some or all in which the shared memory has.

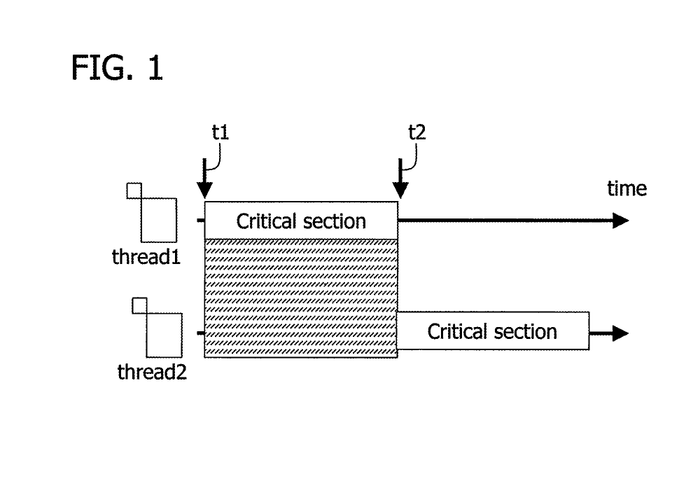

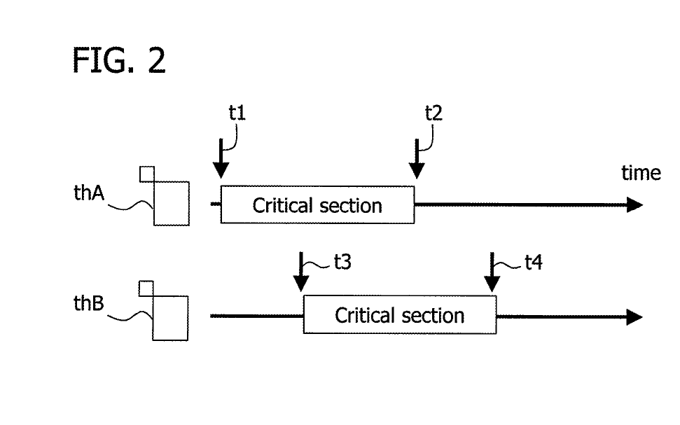

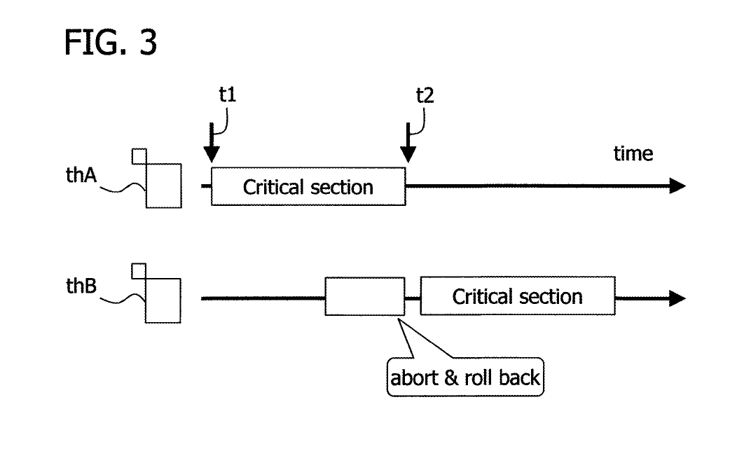

Firstly, according to FIG. 1-FIG. 3, a plurality of methods to realize the exclusive control will be described. FIG. 1 is a diagram explaining the exclusive control of the lock method, and FIG. 2 and FIG. 3 are diagrams explaining the exclusive control of the hardware transaction memory (HTM) method.

[Lock Method]

FIG. 1 illustrates a diagram explaining the exclusive control of the lock method. FIG. 1 exemplifies two threads (thread “thA”, thread “thB”). In addition, arrows depicted in FIG. 1 indicate transition of the time. One thread “thA” and another thread “thB” (below also called as thread “th”) access the same domain (shared memory domain) in the shared memory.

In addition, a critical section depicted in FIG. 1 indicates a section which carries out the processing of a series of instructions including the access instruction for the same shared memory domain (below also called as access processing). The access processing includes either or both writing processing of data for the same shared memory domain or reading processing of the data from the same shared memory domain. That is, the critical section means a part of the program including processing contents which accesses the common resource of a plurality of threads among multi-thread program.

The lock method is a method to realize the exclusive control by waiting a start of the access processing to the shared memory domain by other threads during the access processing to the shared memory domain by one thread. The lock method, for example, is a lock method based on spin lock method, a Mutex method and semaphore method. The embodiment exemplifies a case to use the spin lock method based on the lock variable on the memory.

According to the lock method, each thread “th” acquires a lock at the start time of the access processing for the same shared memory domain, namely the start time of the critical section. When the lock variable indicating the variable on the memory indicates a non-lock state, it is possible to acquire the lock. Therefore, each thread “th” changes the value of the lock variable in a lock state from a non-lock state and acquires the lock.

On the other hand, it is not possible that each thread “th” acquires the lock when the lock variable indicates the lock state. When the lock variable indicates the lock state, it is indicated that the other thread updated the lock variable to the lock state and that the lock is acquiring by other threads. Therefore, each thread “th” waits by the acquisition of the lock until the lock variable is updated in a non-lock state by other threads and the lock is released.

Each thread “th” starts the critical section when acquiring the lock. And when each thread “th” finishes the critical section, the thread updates the lock variable in the non-lock state from the lock state, thereby releases the lock.

According to FIG. 1, the one thread “thA” starts the critical section after the thread acquires the lock at a timing t1. And the thread releases the lock at a timing t2 when the one thread “thA” finishes the critical section.

On the other hand, the other thread “thB” is going to acquire the lock at the timing t3 after the critical section start by the one thread “thA”. But, the other thread “thB” waits by the release of the lock by one thread “thA” because the one thread “thA” is already acquiring the lock. And when the one thread “thA” releases the lock at the timing t2, the other thread “thB” acquires the lock and starts the critical section. The other thread “thB” releases the lock when the other thread “thB” finished the critical section.

As depicted by FIG. 1, according to the lock method, the other thread “thB” waits by the acquisition of the lock during a time when the one thread “thA” acquires the rock. In other words, it is not possible that the other thread “thB” starts the critical section until the one thread “thA” finishes the critical section. Thereby, it is possible that the information processing device avoids that the plurality of threads access to the shared memory domain at the same time, and avoids the occurrence of the inconsistency of the data in the shared memory domain.

In addition, the one thread “thA” and the other thread “thB” may be threads created based on the execution of the same program and may be threads created based on the executions of the different programs each. In addition, the processing of the critical section of the one thread “thA” and the processing of the critical section of the other thread “thB” may be same processing and may be different processing.

Then, according to FIG. 2 and FIG. 3, the exclusive control of the

HTM method will be described.

[HTM Method]

The HTM method is a method using the mechanism of HTM of the hardware in which the CPU (Central Processing Unit) in the information processing device equips with. The HTM method, when a write by other threads for the shared memory domain occurs during the access processing to the shared memory domain by one thread, is a method to realize exclusive control by canceling the access processing by one thread.

The HTM is a mechanism to support parallel programming. The HTM reduces a collision by the exclusion at the time of the execution of the parallel programming, thereby improves performance. For example, the CPU's, such as Rock by Sun Microsystems (registered trademark), Blue Gene/Q Compute chip of IBM (registered trademark), Core i7 of the Haswell micro architecture by Intel (registered trademark), are equipped with mechanism of HTM.

The HTM carries out the sequence of instructions that a user appointed as an atomic and isolated transaction. The HTM guarantees that the processing that the sequence of instructions appointed as the atomic transaction (as follows called as target routine) is carried out as single transaction for other processing that other threads executes in parallel. The user adds a start instruction and an end instruction of the HTM before and after the object routine which is carried out as the atomic transaction at the time of the creation of the program.

When other threads carries out the write processing at an address of the memory of which the target routine targets for the access processing from the start instruction to the end instruction, the HTM detects the conflict (competition of the memory access). The HTM, when detecting the conflict, carries out an abort of the target routine and performs rollback of the target routine. On the other hand, the HTM, when not detecting the conflict, continues the target routine and completes the target routine. In this way, according to the HTM method, each thread “th” carries out a target routine speculatively for running the parallel processing.

Especially the HTM carries out a pre-processing in response to the execution of the start instruction. The pre-processing means storage (save) processing of an internal state (register information) in a processor core and read processing of the data in the memory area that the target routine targets for the access processing (reading, writing) and a storage processing of read data into the temporary domain.

And, according to the HTM method, the thread “th” carries out the write processing by the target routine for the temporary domain (for example, L1 (level 1) cache) which stored by the preprocessing. In other words, the thread “th” waits the reflection of result of the processing of the target routine to the memory until the end instruction of the HTM is executed. In addition, the HTM detects the conflict when other threads write data in an address of the memory of which the target routine targets for the access processing, during period from the start instruction to the end instruction.

The HTM carries out the abort (interruption) of the transaction when the HTM detects the conflict. Especially the HTM stops the processing of the target routine and returns internal state (resister information) of the CPU except EAX register, to the state at the run time of the start instruction (called as rollback). In addition, the HTM deletes result data of the write processing that is stored in the temporary domain. The EAX register maintains the information indicating the reason of aborting it. And the HTM transits the execution of the program into the abort routine which is appointed by the start instruction. For example, the abort routine performs the instruction of the rerun of the target routine based on the value in the EAX register.

On the other hand, the HTM carries out post-processing at the run time of the end instruction of the target routine, when the HTM does not detect the conflict from the start instruction to the end instruction. The post-processing indicates a write processing to write the result data of write processing which is maintained in the temporary domain into the memory.

FIG. 2 and FIG. 3 are diagrams explaining the exclusive control based on the HTM method. In this embodiment, the target routine of the HTM indicates a processing (critical section) to access the shared memory domain. The user adds the start instruction and the end instruction of the HTM before and after the critical section when creating the program.

FIG. 2 is a diagram explaining the exclusive control of the HTM method when the conflict does not occur. The arrow depicted in FIG. 2 indicates transition of the time. In case that the conflict does not occur, in other words, in case that the write by other thread “th” for the shared memory domain does not occur during an execution of the access processing to the shared memory domain by one thread “th”, the HTM makes the access processing of one thread “th” complete.

The one thread “thA” executes the start instruction of the HTM at a timing t1 to start the critical section. As described above, on the run time of the critical section, the one thread “thA” carries out the processing of the critical section for the data, which is read from the shared memory domain and memorized in the temporary domain (local area) at the time of the execution of the start instruction. Therefore, the one thread “thA” does not directly update the shared memory domain during the execution of the critical section.

On the other hand, another thread “thB” executes the start instruction at a timing t3 after the execution of the start instruction by one thread “thA”. Another thread “thB”, as like as the one thread “thA”, carry out the processing of the critical section for the data, which is read from the shared memory domain and memorized in the temporary domain at the time of the execution of the start instruction.

In the example of FIG. 2, the shared memory domain that the critical section in another thread “thB” targets for the access processing is different from the shared memory domain that the critical section in one thread “thA” targets for the access processing. In other words, the example represents a case where write processing by one thread “thA” to the shared memory domain, of which another thread “thB” targets for the access processing in the critical section by another thread “thB”, does not occur.

Therefore, the HTM does not detect the conflict at the time of the execution of the end instruction of one thread “thA” (at the time of the write of the result data to the shared memory domain by one thread “thA”) depicted by a timing t2. Therefore, the HTM does not abort the processing of critical section of another thread “thB”. In addition, the HTM lets the processing of critical section of one thread “thA” make a decision (completion).

And another thread “thB” executes the end instruction of the HTM at a timing t4 when another thread “thB” finishes the critical section. The HTM writes the result data which is updated by the processing of critical section of another thread “thB” into the shared memory domain.

As depicted by FIG. 2, when a write for the shared memory domain by other thread “th” does not occur during the access processing to the shared memory domain by each thread “th”, it is possible that the critical sections of a plurality of threads “thA” and “thB” are executed in parallel. In other words, according to HTM method, it is possible that one thread “thA” and another thread “thB” are executed in parallel when the conflict does not occur.

FIG. 3 is a diagram explaining the exclusive control based on the HTM method when the conflict occurs. In FIG. 3, same elements as elements depicted in FIG. 2 are represented by same signs. When the conflict occurs, in other words, when the write by other thread “th” for the shared memory domain occurs during the access processing to the shared memory domain by one thread “th”, the HTM cancels the access processing by one thread “th”.

According to the example of FIG. 3, the shared memory domain that the critical section of another thread “thB” targets for the access processing overlaps with the shared memory domain that the critical section of one thread “thA” targets for the access processing. In other words, the example represents a case where write processing by another thread “thB” to the shared memory domain, of which another thread “thB” targets for the access processing, occurs by one thread “thA”, during the critical section.

Therefore, the HTM detects the conflict at the time of the execution of the end instruction of one thread “thA” (at the time of the write of the result data to the shared memory domain by one thread “thA”) depicted by a timing t2, and aborts the processing of critical section of another thread “thB”. And the HTM performs rollback of the processing of the critical section of another thread “thB”. In other words, the HTM cancels the processing of the critical section of another thread “thB”.

In addition, when the conflict occurs, another thread “thB” carries out the processing of the critical section again. Another thread “thB”, as same as the processing of the critical section, executes the start instruction of the HTM and starts the critical section. And when conflict does not occur, another thread “thB” finishes the critical section, and executes the end instruction of the HTM at the time of the end.

In this way, when the write by one thread “thA” for the shared memory domain occurs during the access processing to the shared memory domain by another thread “thB”, the HTM cancels the access processing to the shared memory domain by another thread “thB”. Therefore, it is possible to avoid that the memory access processing occurs at the same time for the same shared memory domain and to avoid the inconsistency of the data which is stored in the shared memory domain.

As depicted by FIG. 2 and FIG. 3, the HTM performs rollback of the processing of the critical section only when the HTM detects the competition (conflict) of the memory access. Therefore, according to HTM method, it is possible to execute the critical sections by the plurality of threads “th” in parallel when the competition of the memory access does not occur. Thereby, it is possible to effectively execute the access processing to the shared memory domain.

[Performance by the Method of the Exclusive Control]

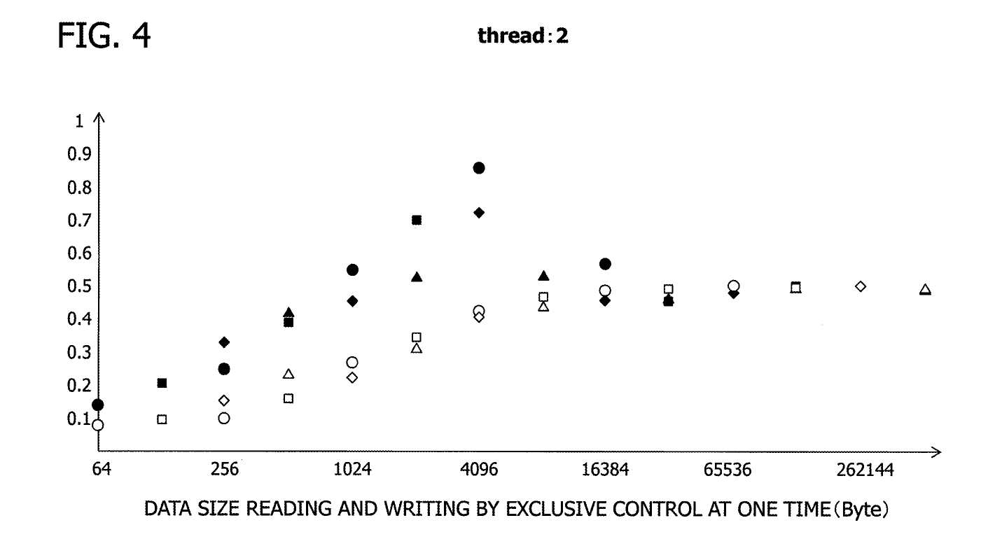

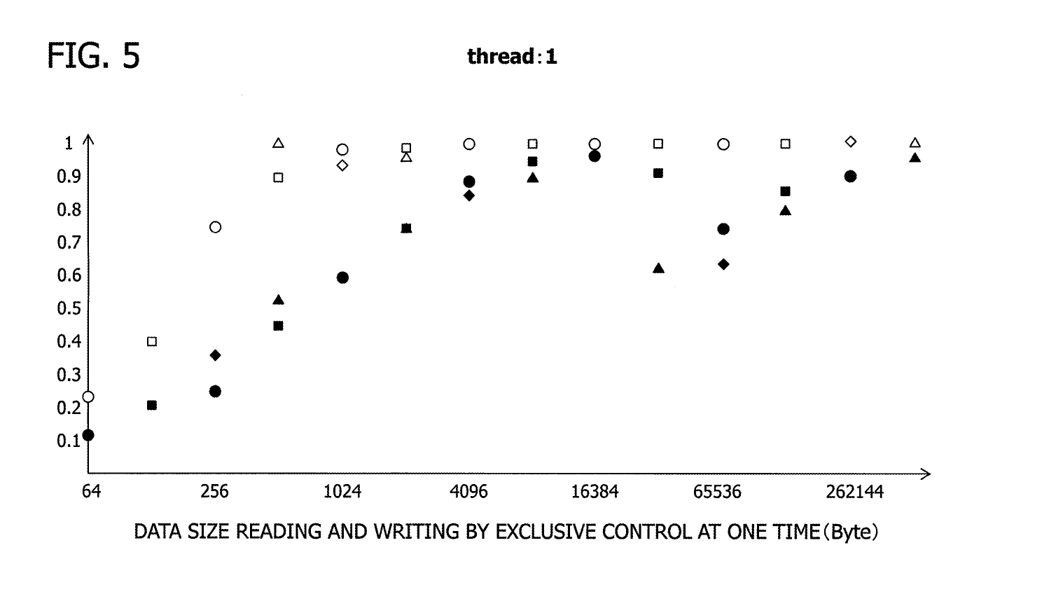

Then, according to FIG. 4 and FIG. 5, a difference in performance of the memory access processing based on the exclusive control methods (the lock method and the HTM method) which are explained by FIG. 1-FIG. 3 will be described. FIG. 4 and FIG. 5 represent performance depending on the number of threads “th” carrying out the accessing the same shared memory domain. The performance in the example in FIG. 4 and FIG. 5 is the performance which is calculated based on the processing time of the program having the access processing to the shared memory domain. That is, value of the performance indicates a time dependent to the processing time of the program having the access processing to the shared memory domain.

FIG. 4 is a diagram indicating the performance of the memory access processing when the number of the threads carrying out to access the same shared memory domain is two. In FIG. 4, the horizontal axis of the graph indicates size (Byte) of target data to read and write based on single exclusive control, and the vertical axis indicates the value which is normalized performance.

The closer the value on the vertical axis is to the value “1”, it is indicated that the processing time of the program is controlled shortly, namely, the performance is high.

FIG. 4 represents performance of the memory access processing based on the exclusive control method in the lock method and the HTM method.

Each of the marks (circle, square, triangle, diamond) illustrated in the graph corresponds with test pattern of the memory access. In addition, each mark illustrated with white color indicates performance of the memory access processing based on the exclusive control of the lock method, and each mark illustrated with black color indicates performance of the memory access processing based on the exclusive control of the HTM method.

According to the graph in FIG. 4, the program based on the exclusive control of the HTM method represents higher performance than a program based on the exclusive control of the lock method when the data size of reading and writing is from 64 Byte to 4096 Byte.

As explained by FIG. 2 and FIG. 3, the HTM carries out the target routine (critical section) speculatively. Therefore, according to the HTM method, it is possible that the information processing device carries out the memory access processing to the shared memory domain by the plurality of threads “th” in parallel, when the competition of the memory access does not occur. In contrast, according to the lock method, it is not possible that the information processing device carries out the memory access processing in parallel. Therefore, in the case that the number of the threads is carried out is two, the program based on the exclusive control of the HTM method represents higher performance than a program based on the exclusive control of the lock method. FIG. 4 also represents above differences of the performance when the number of the threads is carried out is two.

In addition, as represented by FIG. 4, when the size of data for the reading and writing is beyond 4096 Byte, the performance of the program based on the exclusive control of each method is same. That is, the HTM carries out the pre-processing for the run time of the start instruction as described above in FIG. 2 and FIG. 3. The pre-processing includes a processing which retrieves data for the access from the shared memory domain and memorizes in the temporally domain. Therefore, according to the test pattern of FIG. 4, when data size for the reading and writing exceeds a predetermined value, the load of the preprocessing becomes higher. Therefore the performance of the program based on the exclusive control of the HTM method becomes equal to the performance of the program based on the exclusive control of the lock method even when the number of the threads is carried out is two.

FIG. 5 is a diagram indicating the performance of the memory access processing when the number of the threads which is carried out to access the same shared memory domain is single. The horizontal axis, the vertical axis and the marks of the graph in FIG. 5 are similar to that in FIG. 4. As explained by FIG. 4, each mark illustrated with white color indicates performance of the memory access processing based on the exclusive control of the lock method, and each mark illustrated with black color indicates performance of the memory access processing based on the exclusive control of the HTM method.

According to the graph in FIG. 5, the program based on the exclusive control of the HTM method represents lower performance than a program based on the exclusive control of the lock method. Therefore, a program based on the exclusive control of the lock method represents higher performance than a program based on the exclusive control of the HTM method when the number of the threads is single unlike the case that the number of the threads, which is carried out accessing the same shared memory domain, is two in FIG. 4.

As mentioned by FIG. 2 and FIG. 3, in the HTM method, the HTM performs the pre-processing and the post-processing. In contrast, the lock method does not perform pre-processing and post-processing. Therefore, the lock method represents smaller overhead than the HTM method. Therefore, when the number of the threads “th”, which carry out the accessing to the same shared memory domain, is only one, the program based on the exclusive control method of the lock method, of which the overhead is small, represents higher performance than a program based on the exclusive control of the HTM method.

As depicted by FIG. 4 and FIG. 5, the method of the exclusive control that the performance is higher among the HTM method and the lock method is different according to a number of threads “th” carrying out accessing to the same shared memory domain. In other words, the performance of the HTM method is higher when the number of the threads carrying out to access the same shared memory domain is a plural number, whereas the performance of the lock method is higher when the number of threads is single.

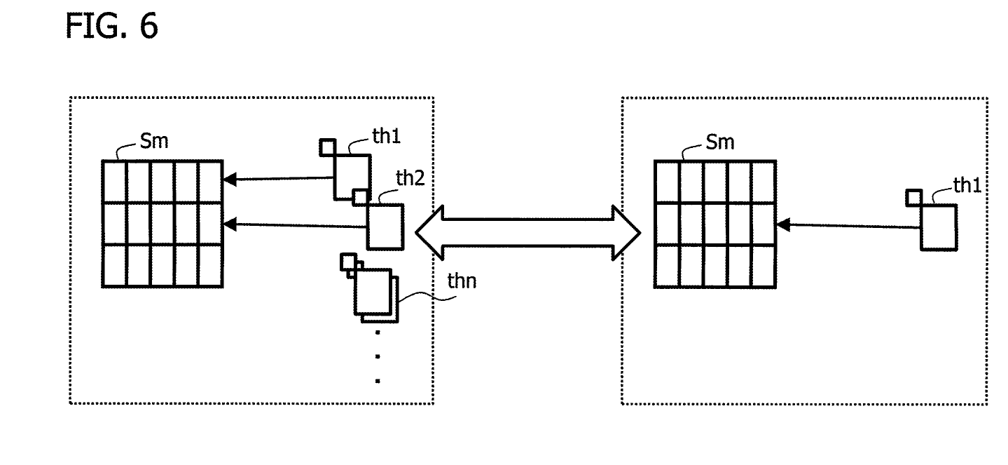

FIG. 6 is a diagram explaining a change of the number of the threads at the time of the execution of the program schematically. The number of threads “th” during execution (run) at the time of the program execution is not constant. The number of threads “th” carrying out changes depending on a change of the processing that a program carries out every hour. Therefore, the number of threads “th” carrying out accessing to the same shared memory domain “Sm” changes depending on a change of the processing that a program carries out.

As depicted by FIG. 6, in one time of period, the number of threads “th” (“th1”-“thn”) carrying out accessing to the same shared memory domain “Sm” is more than two, whereas a number of threads “th1” carrying out accessing to same shared memory domain “Sm” in another time of period changes in single. In this way, the number of threads “th”, which carry out accessing to the same shared memory domain “Sm”, changes depending on the processing of program. Therefore, it is not easy to select the method of the appropriate exclusive control among the lock method and the HTM method at the time of the creation of the program beforehand.

### Summary of the Embodiment

Therefore, the information processing device according to the embodiment judges whether or not a plurality of threads “th”, which access the shared memory domain “Sm”, are carried out when the thread “th” executes an access processing to access the shared memory domain “Sm”. And the information processing device carries out the access processing to the shared memory domain “Sm” based on the first method (lock method) when judging that single thread “th” is carried out. In addition, the information processing device carries out the access processing to the shared memory domain “Sm” based on the second control (HTM method) when judging that the plurality of threads “th” are carried out.

As described by FIG. 1, according to the lock method, the information processing device, during an executing of the access processing to the shared memory domain “Sm” by one thread “th”, waits a start of the access processing to the shared memory domain “Sm” by another thread “th”. In addition, as described in FIG. 2 and FIG. 3, according to the HTM method, the information processing device, when the write by another thread “th” for the shared memory domain “Sm” occurs during an execution of the access processing to the shared memory domain “Sm” by one thread “th”, cancels the access processing.

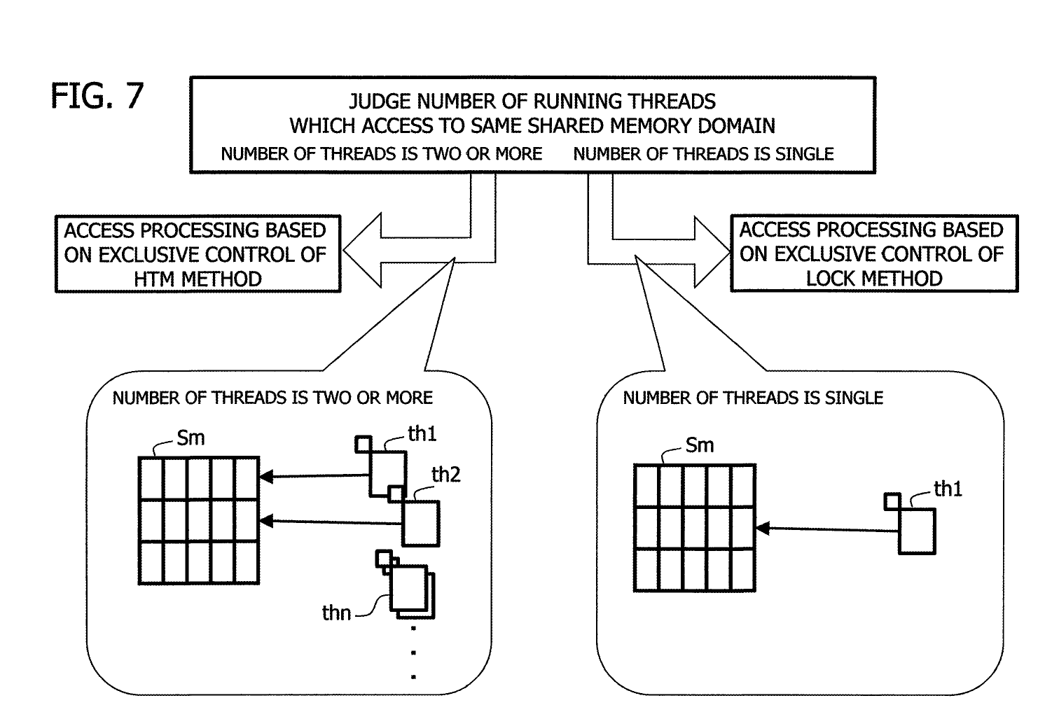

FIG. 7 is a diagram explaining a summary of the processing of the information processing device according to the embodiment. In FIG. 7, same elements as that in FIG. 6 are indicated by same sign as in FIG. 6.

In other words, as depicted by FIG. 7, the information processing device selects the lock method when the number of threads “th” carrying out accessing to the same shared memory domain “Sm” is not plural, namely single, whereas the information processing device selects the HTM method when the number of threads “th” is plural. In other words, the information processing device changes a method of the exclusive control depending on the change of the number of running threads “th” (namely, during a run) to access the same shared memory domain “Sm” during the execution of the program.

Therefore, it is possible that the information processing device, based on a running condition of the thread “th” which access the same shared memory domain “Sm”, selects and changes a method of the exclusive control of the higher performance during the execution of the program. Therefore, it is possible that the information processing device carries out the access processing to the shared memory domain “Sm” by each thread “th” effectively while maintaining consistency of the shared memory domain “Sm”. In other words, it is possible that the information processing device advances performance of the exclusive control of the access processing to the shared memory domain “Sm”.

[Hardware Constitution of Information Processing Device]

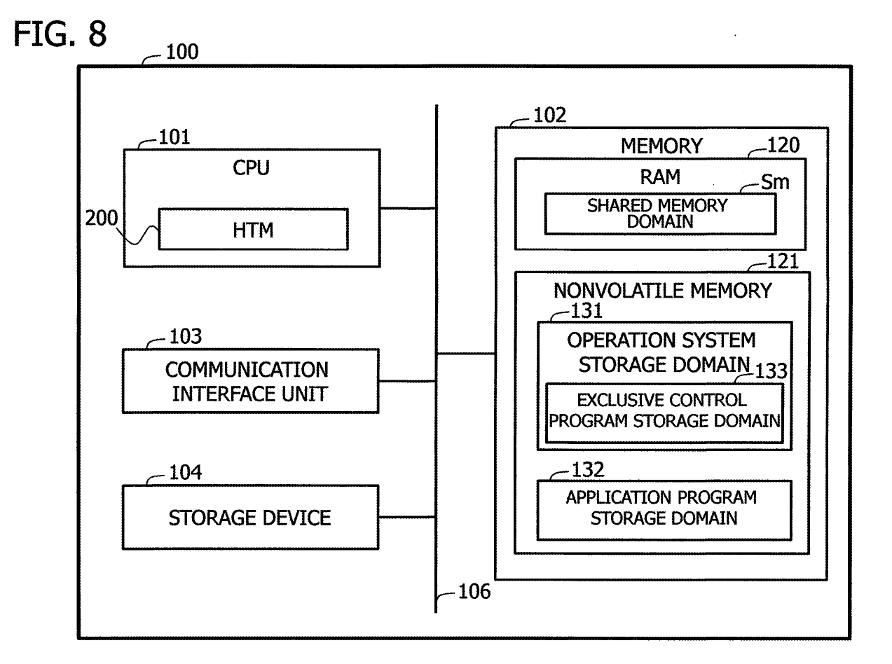

FIG. 8 is a diagram of hardware constitution of information processing device 100 according to the embodiment. In FIG. 8, the information processing device 100 has a CPU 101, a memory 102, a communication interface unit 103, a storage device 104, for example. The all parts are connected through a bus 106 mutually. The memory 102 includes RAM (Random Access Memory) 120 and nonvolatile memory 121, etc.

The CPU 101 is connected to the memory 102, etc. through the bus 106 and controls the whole of information processing device 100. In addition, the CPU 101 has a plurality of processor cores, which is not illustrated in FIG. 8, and realizes multi-thread processing. In addition, the CPU 101 depicted in FIG. 8 includes a mechanism of HTM 200 which is explained in FIG. 2 and FIG. 3. In addition, the communication interface unit 103 communicates with other devices (not illustrated in FIG. 8) and performs the transmission and reception of data.

The RAM 120 in the memory 102 memorizes the data which the CPU 101 processes. In addition, for example, the RAM 120 has shared memory domain (shared memory area) “Sm”. But, not a thing limited to this example, the nonvolatile memory 121 may have the shared memory domain “Sm”.

The nonvolatile memory 121 in the memory 102 includes operation system storage domain 131 and application program storage domain 132. For example, the nonvolatile memory 121 indicates nonvolatile semiconductor memory.

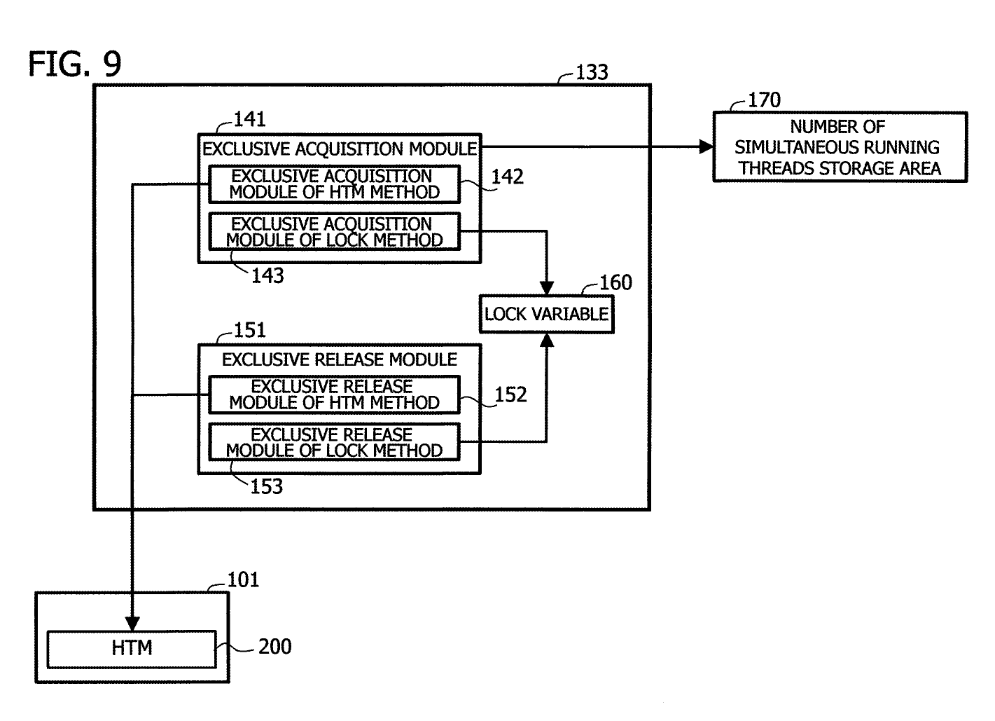

The operation system (following, called as operation system 131) in the operation system storage domain 131 realizes the processing of operation system working with the information processing device 100 by the execution of the CPU 101. In addition, the operation system storage domain 131 has exclusive control program storage domain 133. The exclusive control program (following, called as exclusive control program 133) in the exclusive control program storage domain 133 realizes exclusive control processing of the shared memory domain “Sm”. The processing of exclusive control program 133 will be mentioned later according to FIG. 9.

The application program (following, called as application program 132) in the application program storage domain 132 works on the operation system 131 by the execution of the CPU 101 and realizes predetermined processing. In addition, the application program 132 calls the exclusive control program 133 when the application accesses to the shared memory domain “Sm”.

[Software Block of Information Processing Device]

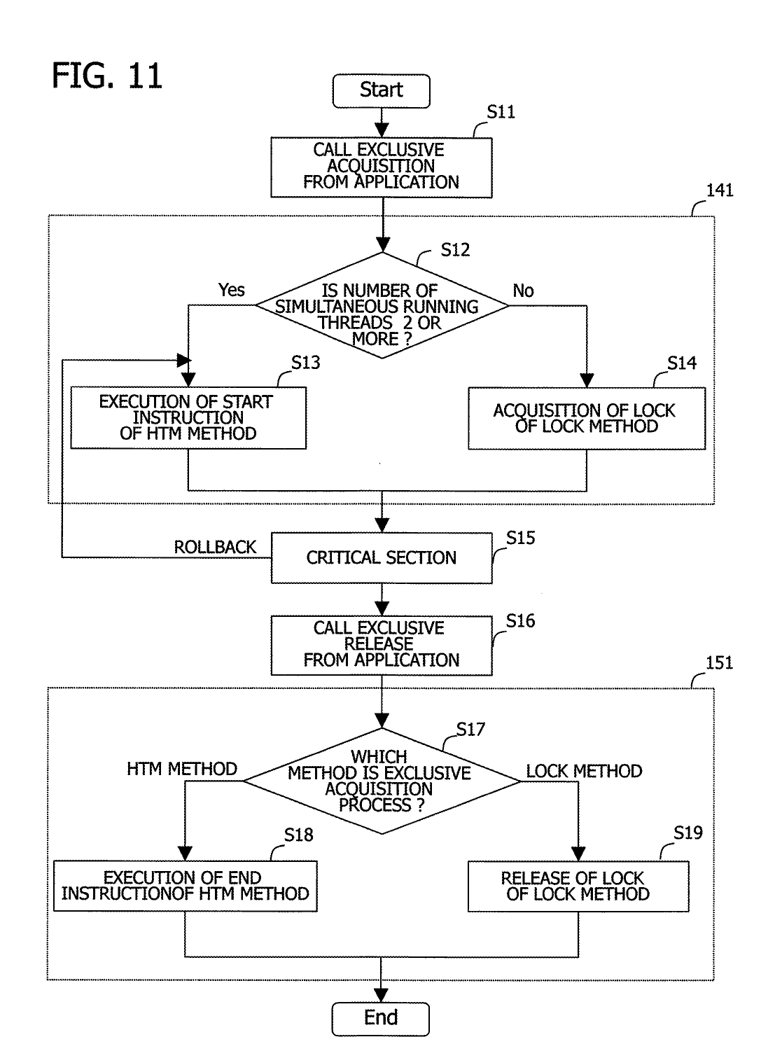

FIG. 9 is a software block diagram of the information processing device 100 indicated in FIG. 8. The exclusive control program 133 indicated in FIG. 8 has an exclusion acquisition module 141 and an exclusion release module 151. The details of the processing of each module will be mentioned later according to a flow chart diagram in FIG. 11.

The exclusion acquisition module 141 has an exclusion acquisition module 142 of the HTM method and an exclusion acquisition module 143 of the lock method. In addition, the exclusion release module 151 has an exclusion release module 152 of the HTM method and an exclusion release module 153 of the lock method.

The exclusion acquisition module 141 refers to the number of the simultaneous running threads storage area 170 in the memory such as the RAM 120 and acquires the number of the threads carrying out accessing to the same shared memory domain “Sm”. And the exclusion acquisition module 141 calls one of the exclusion acquisition module 142 of the HTM method or the exclusion acquisition module 143 of the lock method based on the number of the threads which is acquired.

The exclusion acquisition module 142 of the HTM method performs start processing of the exclusive control based on the HTM method. Especially the exclusion acquisition module 142 of the HTM method calls the start instruction which notifies HTM 200 of a start of the transaction (target routine) that the HTM 200 (referring to FIG. 8) to be processed.

The exclusion acquisition module 143 of the lock method performs start (acquisition) processing of exclusive control based on the lock method according to the lock variable 160 on the memory such as RAM 120. Especially the exclusion acquisition module 143 of the lock method waits by the start of the critical section until the lock variable 160 changes in a non-lock state. Then the exclusion acquisition module 143 of the lock method updates the lock variable 160 in a lock state for another thread when the lock variable 160 changes in a non-lock state by one thread.

The exclusion release module 151 refers to the number of the simultaneous running threads storage area 170 and acquires the number of the threads carrying out to access the same shared memory domain “Sm” like the exclusion acquisition module 141. And the exclusion release module 151 calls one of exclusion release module 152 of the HTM method or exclusion release module 153 of the lock method based on the number of the threads which is acquired.

The exclusion release module 152 of the HTM method performs end processing of the exclusive control based on the HTM method. Especially the exclusion release module 152 of the HTM method calls an end instruction which notifies the HTM 200 of the end of the transaction that the HTM 200 to be processed. In addition, the exclusion release module 153 of the lock method performs end (release) processing of exclusive control based on the lock method. Especially the exclusion release module 153 of the lock method updates the lock variable 160 in a non-lock state.

[The Number of the Threads]

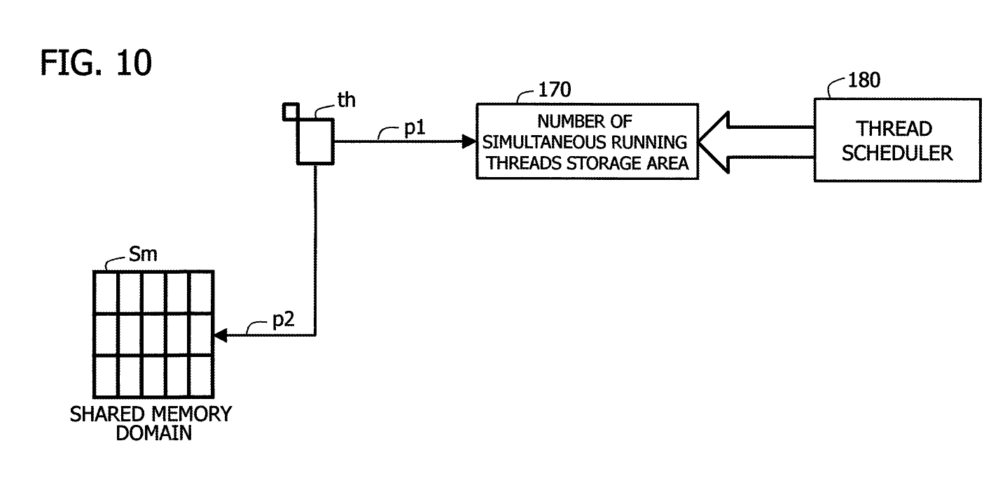

FIG. 10 is a diagram explaining the acquisition processing of the number of the threads, which is memorized in the number of the simultaneous running threads storage area 170 (FIG. 9), carrying out accessing to the same shared memory domain “Sm”.

The information processing device 100 performing the parallel computation carries out thread scheduler 180, for example. The thread scheduler 180 is a process of the operation system 131 which performs the schedule for the thread “th”. The thread scheduler 180 selects the thread of which the execution is started and assigns it to a processor core (not illustrated in FIG. 10) in the CPU 101 (referring to FIG. 8). In addition, the thread scheduler 180 acquires the number of the threads carrying out to access the same shared memory domain (also called as the number of the threads which run at the same time; numThreads) and memorizes in the number of the simultaneous running threads storage area 170.

For example, each thread “th” refers to the number of the simultaneous running threads storage area 170 and acquires the number of the threads carrying out the execution to access the same shared memory domain “Sm” at the same time (sign “p1” in FIG. 10). And the thread “th” accesses the shared memory domain “Sm” based on a method of the exclusive control which is selected based on the number of the threads which is acquired (sign “p2” in FIG. 10).

In addition, the method, in which the thread “th” acquires the number of the running threads which accesses the same shared memory domain “Sm”, is not a thing limited to an example of FIG. 10. For example, the operation system 131 in the information processing device 100 may administrates the number of the running threads which accesses to the same shared memory domain “Sm”. In this case the thread “th” acquires the number of the running threads which accesses to the same shared memory domain “Sm” by carrying out system call of the operation system 131.

Then, according to FIG. 11, a flow of the processing of exclusive control program 133 which is explained in FIG. 8 and FIG. 9 will be described.

[Processing of Exclusive Control Program 133]

FIG. 11 is a flow chart diagram explaining a flow of the processing of exclusive control program 133 in the information processing device 100 according to the embodiment.

S11: The application program 132 calls the exclusion acquisition module 141 in the exclusive control program 133 before the execution start of the critical section.

S12: The exclusion acquisition module 141 refers to the number of the simultaneous running threads storage area 170 which is explained in FIG. 10 and judges whether or not the number of the simultaneous running threads, which access the same shared memory domain “Sm” at the same time, is more than two.

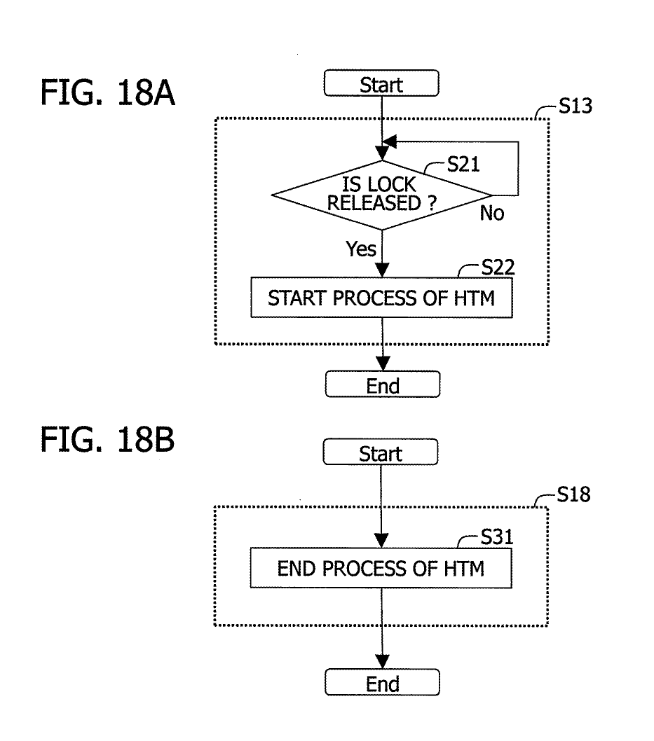

S13: The exclusion acquisition module 141, when the number of the simultaneous running threads is more than two (Yes of S12), calls the exclusion acquisition module 142 of the HTM method. The exclusion acquisition module 142 of the HTM method executes the execution start instruction of the HTM method and carries out the pre-process of the HTM method. The details of the processing in the process S13 will be mentioned later in a flow chart of FIG. 18.

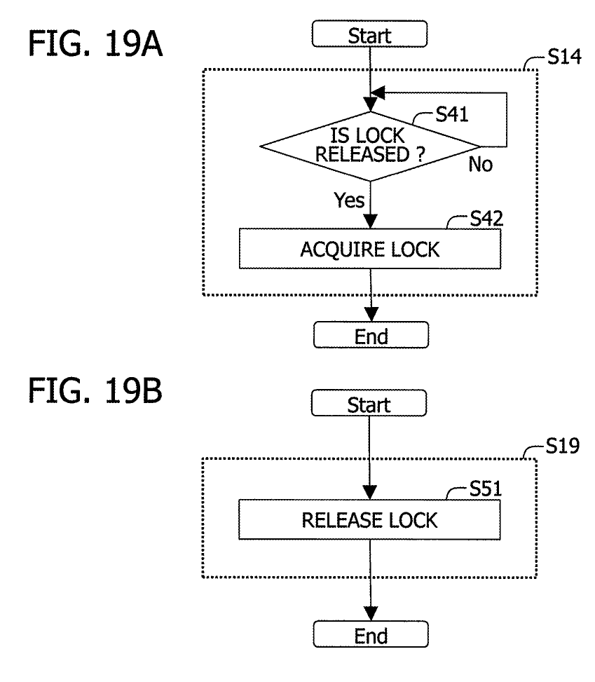

S14: On the other hand, when the number of the simultaneous running threads is single (No in S12), the exclusion acquisition module 141 calls the exclusion acquisition module 143 of the lock method. The exclusion acquisition module 143 of the lock method acquires the lock based on the lock variable 160. The details of the processing in the process S14 will be mentioned later in a flow chart of FIG. 19.

S15: When the exclusion acquisition processing (process S13 or process S14) is finished, the exclusion acquisition module 141 returns control to the application program 132. And the thread carries out the access processing (critical section) to the shared memory domain “Sm” which is processing of the application program 132.

In addition, in a case of selecting the exclusive control of the HTM method, when the HTM 200 detects the conflict (competition of the memory access) during the execution of the critical section, the HTM 200 aborts the critical section and performs the rollback. For example, the thread “th” executes the execution start instruction of the HTM method again, when the thread “th” carries out the processing of critical section again.

S16: When the critical section is finished, the application program 132 calls the exclusion release module 151 in the exclusive control program 133.

S17: The exclusion release module 151 judges which the exclusion acquisition processing (S13, S14) is based on the HTM method or the lock method.

S18: When the exclusion acquisition processing is based on the HTM method (described as HTM method in FIG. 11), the exclusion release module 151 calls the exclusion release module 152 of the HTM method. The exclusion release module 152 of the HTM method executes the execution end instruction of the HTM method and performs post-processing of the HTM method. The details of the processing in the process S18 will be mentioned later in a flow chart of FIG. 18.

S19: When the exclusion acquisition processing is based on the lock method (described as lock method in FIG. 11), the exclusion release module 151 calls the exclusion release module 153 of the lock method. The exclusion release module 153 of the lock method releases the lock based on the lock variable 160.

The details of the processing in the process S19 will be mentioned later in a flow chart of FIG. 19.

As depicted by FIG. 11, the exclusive control program 133 carries out the process of the exclusion release module 151 according to the method like the method of exclusion acquisition module 141. Therefore, it is possible that the exclusive control program 133 carries out the process of exclusion release based on the exclusive control method at the time of the exclusion acquisition appropriately even though the number of the threads, which carry out to access the same shared memory domain “Sm”, changes.

Then, change of the exclusive control method, when a method of the exclusive control is selected according to the flow chart in FIG. 11, will be described.

[Change of Exclusive Control]

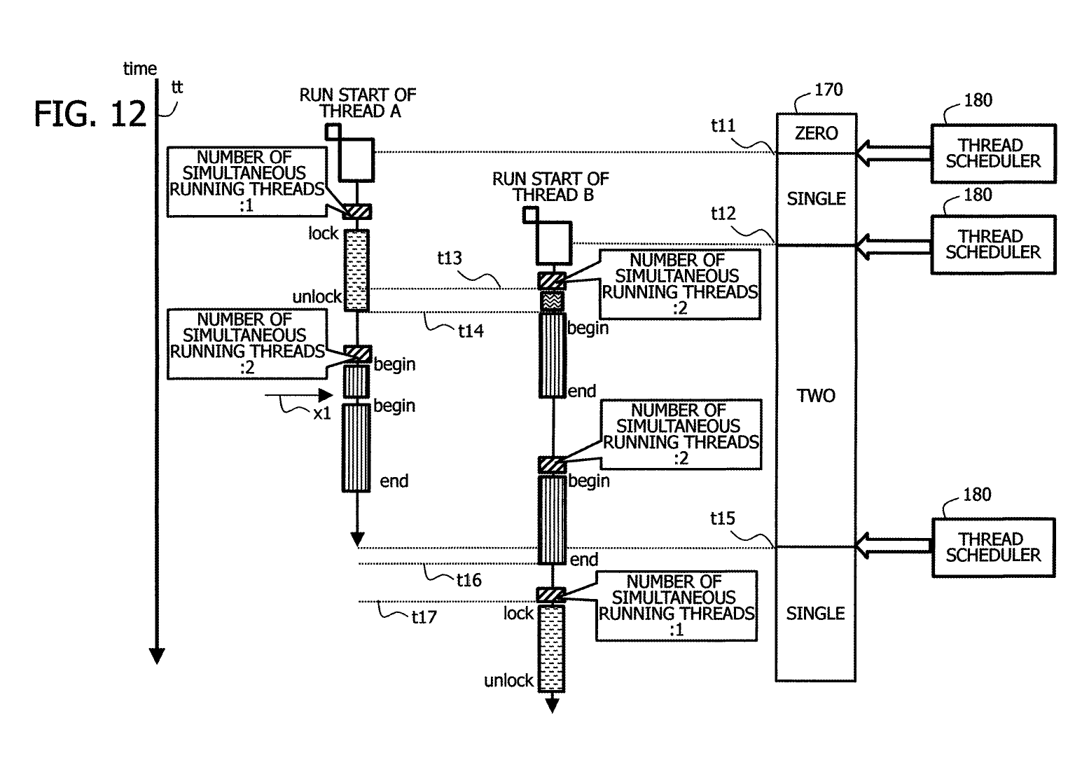

FIG. 12 is a diagram explaining the change of the exclusive control method schematically. In FIG. 12, an arrow “tt” indicates transition of the time. In addition, the rectangle which illustrates with the horizontal line of the dotted line indicates a critical section based on the exclusive control of the lock method, and the rectangle which illustrates with the vertical line indicates a critical section based on the exclusive control of the HTM method. In addition, the rectangle which illustrated with the slanted line of the upward slant to the right indicates the acquisition processing of value in the number of the simultaneous running threads storage area 170 (referring to FIG. 10) (the number of the simultaneous running threads accessing to the same shared memory domain).

FIG. 12 exemplifies the case that the application program 132 (referring to FIG. 8) carries out the threads “thA” and “thB”. In addition, FIG. 12 exemplifies a case that the thread “thB” starts a run after a start of a run of the thread “thA”. The threads “thA”, “thB” access the same shared memory domain “Sm”.

The application program 132 starts a run of the thread “thA” at a timing t11. Due to a run start of the thread “thA”, the thread scheduler 180 updates a value in the number of the simultaneous running threads storage area 170 to “1” from “0”.

The thread “thA” starts the critical section before the thread “thB” starts a run. The thread “thA” calls the exclusion acquisition module 141 (S11 in FIG. 11) and selects the lock method based on value “1” in the number of the simultaneous running threads storage area 170 of which the thread scheduler 180 updated (S12). And the thread “thA” acquires the exclusion based on the lock method (S14) and carries out the critical section (S15).

On the other hand, the application program 132 starts a run of thread “thB” during a run of thread “thA” (at a timing t12 in FIG. 12). Due to a run start of thread “thB”, the thread scheduler 180 updates a value in the number of the simultaneous running threads storage area 170 to “2” from “1”. And the thread “thB” selects the HTM method based on information of value “2” in the number of the simultaneous running threads storage area 170 before the start of the critical section (at a timing t13 in FIG. 12) (S12).

However the thread “thA” is already acquiring the exclusion based on the lock method at the time of a timing t13. The function of the exclusive control does not establish even if the exclusive controls are carried out based on a different exclusive control method for the same shared memory domain “Sm”. In other words, it is necessary that the exclusive control method for the same shared memory domain “Sm” is the same exclusive control method. Therefore, the thread “thB” waits by the exclusion acquisition processing based on the HTM method until thread “thA” releases the exclusion based on the lock method (S19 of FIG. 11).

And when the thread “thA” releases the exclusion, at a timing t14 (S19 of FIG. 11), based on the method (namely, a lock method) which is selected at the time of the exclusion acquisition, the thread “thB” carries out the process of the exclusion acquisition of the HTM method (S12, S13). And the thread “thB” starts the critical section (S15). The thread “thB”, after completion of the critical section, performs release processing of exclusion based on the HTM method selected at the time of the exclusion acquisition.

In this way, when a plurality of threads “th” are not carried out, the thread “thA” selects the lock method. However, during the exclusion acquisition of the lock method, there may a case that new thread “thB” starts a run and a value in the number of the simultaneous running threads storage area 170 changes to “2” from “1”. In this case the thread “thB” waits by a start of the access processing (critical section) to shared memory domain “Sm” based on the exclusive control of the HTM method during the access processing to the shared memory domain “Sm” based on the exclusive control of the lock method.

In other words, when the information processing device 100 starts the execution of new thread and changes to a state of carrying out a plurality of threads during that the single thread is carried out, the information processing device 100 waits a start of the access processing based on the HTM method by the new thread, until the access processing based on the lock method finishes. In this way it is possible that the information processing device 100 realizes the exclusive control according to the exclusive control method which is common to the plurality of threads “th” appropriately, even if the number of the threads carrying out accessing the same shared memory domain “Sm” increases from one to multiple pieces during the access processing.

In FIG. 12, the number of the simultaneous running threads storage area 170 is value “2” until a timing t14 to a timing t15 when the thread “thA” finishes a run. Therefore, the threads “thA” and “thB” perform access processing of shared memory domain “Sm” (critical section) based on the exclusive control of the HTM method.

In addition, the HTM 200 aborts the critical section of the thread “thB” and performs the rollback when the competition of the memory access occurs between the critical section of the thread “thB” at the run time of the end instruction of the critical section of thread “thA” (×1). When carrying out the critical section again, the thread “thB” acquires the exclusion based on HTM method according to a value in the number of the simultaneous running threads storage area 170 (S13) and carries out the critical section (S15).

And when the thread “thA” stops (finishes) a run at a timing t15, the thread scheduler 180 updates the number of the simultaneous running threads storage area 170 to value “1” from value “2”. In addition, the thread “thB” carries out the processing of exclusion release based on a method (namely, HTM method), which is selected at the time of the exclusion acquisition, at the time of the end of the critical section (a timing t16), even after the number of the simultaneous running threads storage area 170 was updated to value “1” (S18).

In other words, when the information processing device 100 finishes the execution of any one of threads in a case of carrying out the plurality of threads and a state transitions to the state that the single thread is carried out, the information processing device 100 carries out the end (exclusive release) processing based on the HTM method at the end of the access processing. In this way it is possible that the information processing device 100 carries out the processing of the exclusion release based on an exclusive control method at the time of the exclusion acquisition appropriately, even if the number of the threads carrying out accessing the same shared memory domain “Sm” decreases from multiple pieces to single during the access processing.

And the thread “thB” starts the critical section at a timing t17 after a stop of the thread “thA”. Then the thread “thB” selects the lock method according to value “1” in the number of the simultaneous running threads storage area 170 (S12 in FIG. 11). Therefore, the thread “thB” performs the access processing of the shared memory domain “Sm” (critical section) based on the exclusive control of the lock method.

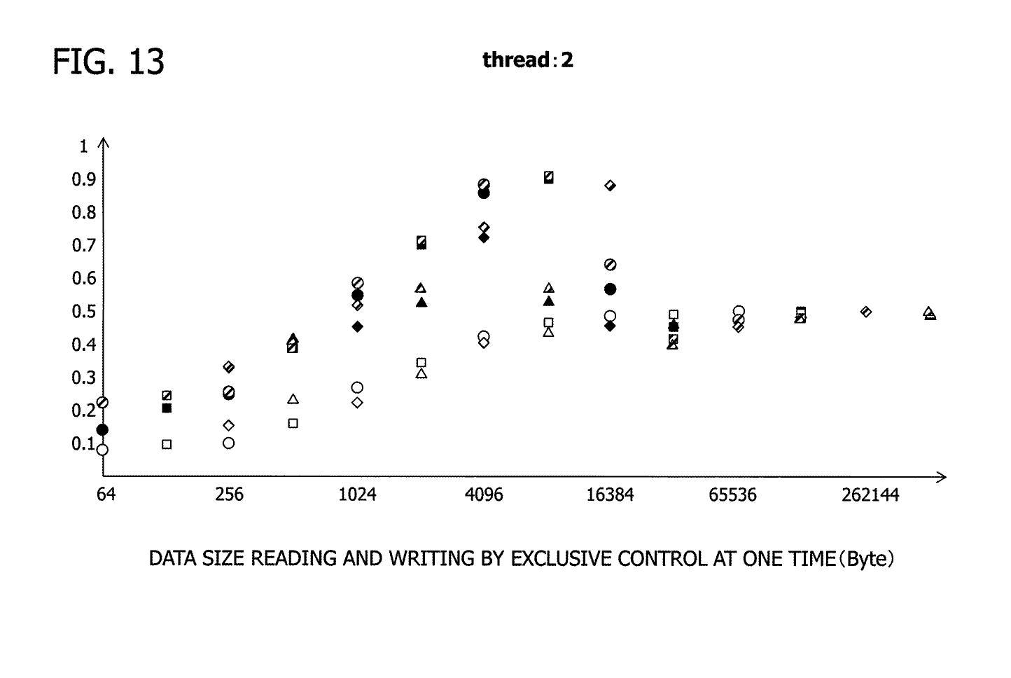

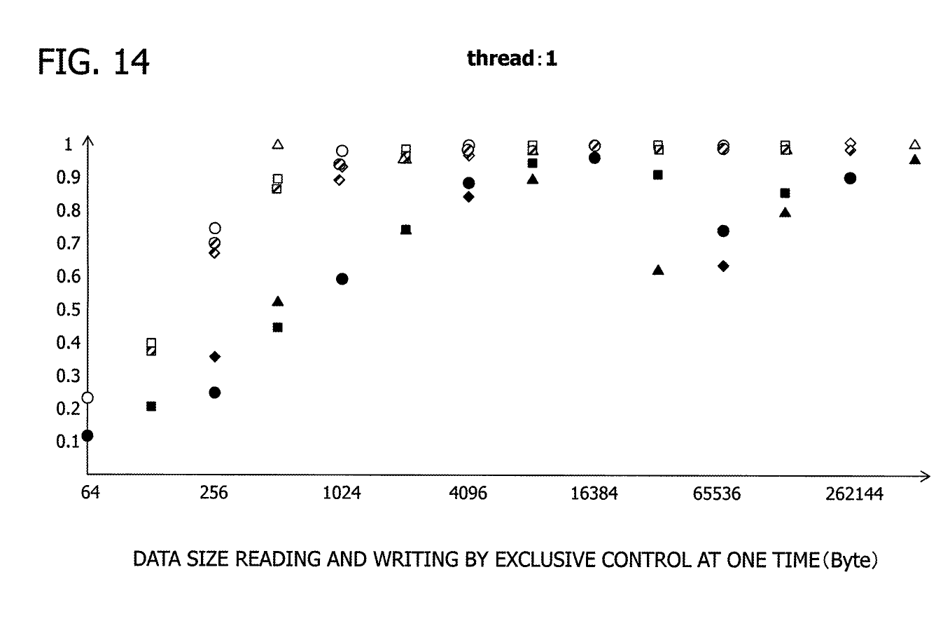

Then, according to FIG. 13 and FIG. 14, performance of the memory access processing according to the embodiment will be described. FIG. 13 and FIG. 14 indicate the performance of the exclusive control method according to the embodiment depending on a pattern of the number of threads “th” carrying out accessing the same shared memory domain “Sm”.

[Performance of the Exclusive Control Method According to Embodiment]

FIG. 13 is a diagram indicating the performance of the memory access processing based on the exclusive control method according to the embodiment when the number of threads “th” carrying out accessing the same shared memory domain “Sm” is two. FIG. 13 indicate the performance of the memory access processing based on the exclusive control method according to the embodiment in addition to the performances of the memory access processing based on the exclusive control methods of the lock method and the HTM method explained by FIG. 4.

The elements indicated by the horizontal axis, the vertical axis and the marks in the graph of FIG. 13 are similar to that of FIG. 4 and FIG. 5. Each marks, which is indicated with the slanted line of the upward slant to the right in FIG. 13, indicates the performance of the memory access processing based on the exclusive control method according to the embodiment.

When the number of threads “th” carrying out accessing the same shared memory domain “Sm” is more than two, the exclusive control method according to the embodiment adopts the exclusive control method of the HTM method. Therefore, according to the graph in FIG. 13, the performance of the memory access processing of based on the exclusive control method according to the embodiment is similar to the performance of the memory access processing based on the HTM method indicated by a black mark.

FIG. 14 is a diagram indicating the performance of the memory access processing based on the exclusive control method according to the embodiment, when the number of threads “th” carrying out accessing the same shared memory domain “Sm” is single. The elements indicated by the horizontal axis, the vertical axis and the marks in the graph of FIG. 14 are similar to that of FIG. 13.

The exclusive control method according to the embodiment adopts the exclusive control method of the lock method when the number of threads “th” carrying out accessing the same shared memory domain “Sm” is single. Therefore, according to the graph in FIG. 14, the performance of the memory access processing of based on the exclusive control method according to the embodiment is similar to the performance of the memory access processing based on the lock method indicated by the white mark.

As illustrated by FIG. 13 and FIG. 14, the performance of the memory access processing based on the exclusive control method according to the embodiment is similar to the performance of the memory access processing based on the method that the performance is higher according to the number of threads “th” carrying out among the lock method and the HTM method. In this way, it is possible that the information processing device 100 carries out memory access processing effectively and advances the performance of the exclusive control by changing the exclusive control method to an exclusive control method having a higher performance based on a running condition of thread “th” during the execution of the program.

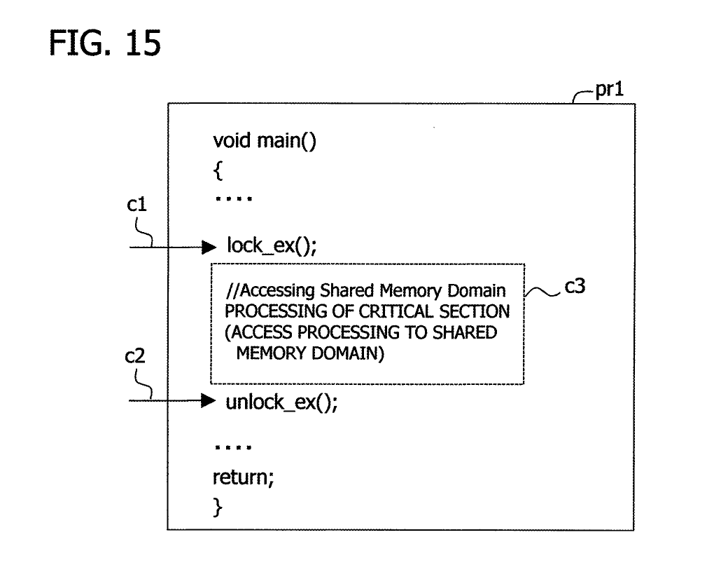

Then, according to FIG. 15-FIG. 17, an example of application program 132 represented by FIG. 8, examples of programs of exclusion acquisition module 141 and exclusion release module 151 represented by FIG. 9 will be described.

[Example of the Program]

FIG. 15 is a diagram indicating an example of part of program pr1 of the application program 132 represented by FIG. 8. In FIG. 15, a description c1 indicates a call instruction of the exclusion acquisition module 141 (referring to FIG. 9), and a description c2 indicates a call instruction of the exclusion release module 151 (referring to FIG. 9). In addition, instruction group c3 is an instruction which carries out the processing (critical section) to access the shared memory domain “Sm”.

The program pr1 carries out the description c1 before the execution start of the critical section (c3, S15 of FIG. 11). Thereby, the program pr1 calls the exclusion acquisition module 141 according to the embodiment and acquires the exclusion (S11 of FIG. 11). In addition, the program pr1 carries out the description c2 after end of the critical section (c3, S15). Thereby, the program pr1 calls the exclusion release module 151 according to the embodiment and releases the exclusion.

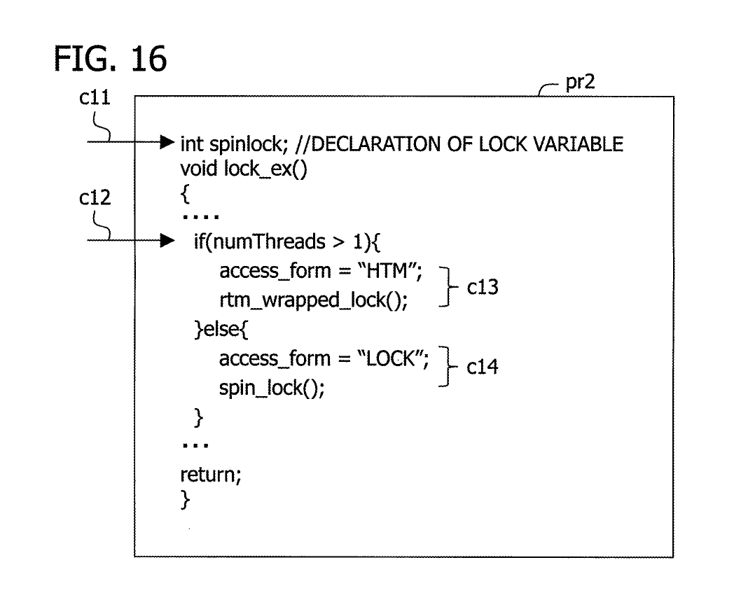

FIG. 16 is a diagram indicating an example of the program pr2 of the exclusion acquisition module 141 represented by FIG. 9 and FIG. 11. The exclusion acquisition module 141 represented by FIG. 16 is a module called by the description c1 represented by FIG. 15.

The description c11 represented by FIG. 16 indicates a declarative statement of the lock variable “spinlock” 160. In addition, the description c12 is a description to judge whether or not a value of number of the threads “numThreads” (the number of the simultaneous running threads storage area 170 of FIG. 10) carrying out to access the same shared memory domain “Sm” is bigger than value “1” (S12 of FIG. 11).

The description c13 indicates processing of a case that a value of number of the threads “numThreads” carrying out is bigger than value “1” (Yes of S12 in FIG. 11). The description c13 indicates an instruction, which sets method “access_form” of the exclusive control to the HTM method and calls the exclusion acquisition module 142 (rtm_wrapped_lock( )) of the HTM method (S13).

The description c14 indicates the processing when the value of number of the threads “numThreads” carrying out is less than a value “1” (No of S12 in FIG. 11). The description c14 indicates an instruction, which sets method “access_form” of the exclusive control to the lock method and calls the exclusion acquisition module 143 (spin_lock( )) of the lock method (S14). In addition, not illustrated in FIG. 16, but the exclusion acquisition module 143 (spin_lock( )) of the lock method refers to the lock variable “spinlock” 160.

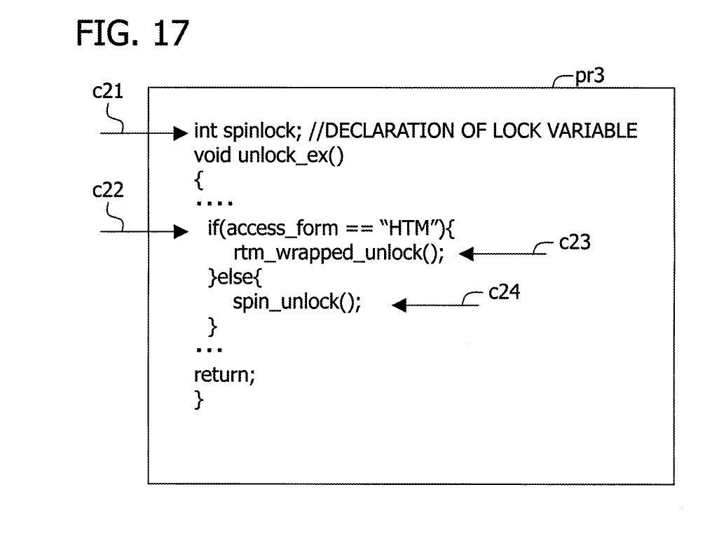

FIG. 17 is a diagram indicating an example of program pr3 of the exclusion release module 151 represented by FIG. 9 and FIG. 11. The exclusion release module 151 in FIG. 17 is a module which is called by the description c2 represented by FIG. 15.

The description c21 represented by FIG. 17 indicates a declarative statement of the lock variable “spinlock” 160. In addition, the description c22 is a description to judge whether or not method “access_form” of the exclusive control set by the exclusion acquisition module 141 is the HTM method (S17 of FIG. 11).

The description c23 indicates an instruction (S18) which calls the exclusion release module 152 (rtm_wrapped_unlock( )) of the HTM method when the method “access_form” of the exclusive control set by the exclusion acquisition module 141 is the HTM method (HTM method of S17 of FIG. 11). In addition, the description c24 indicates an instruction which calls the exclusion release module 153 (spin_unlock( )) of the lock method (S19) when the method “access_form” of the exclusive control set by the exclusion acquisition module 141 is the lock method (lock method of S17). In addition, not illustrated in FIG. 17, but the exclusion release module 153 (spin_unlock( )) of the lock method refers to the lock variable “spinlock” 160.

Then, flows of the processing of the exclusion acquisition module 142 of the HTM method and the exclusion release module 152 of the HTM method will be described according to FIG. 18A and FIG. 18B. In addition, flows of the processing of the exclusion acquisition module 143 of the lock method and the exclusion release module 153 of the lock method will be described according to FIG. 19A and FIG. 19B.

[Processing of HTM Method]

FIG. 18A and FIG. 18B are diagrams of flow chart explaining flows of the processing of exclusion acquisition module 142 of the HTM method and the exclusion release module 152 of the HTM method.

FIG. 18A is a diagram of flow chart indicating the flow of the disposal of exclusion acquisition module 142 of the HTM method (S13 of FIG. 11).

S21: The exclusion acquisition module 142 of the HTM method judges whether or not the lock based on the lock method is released. As illustrated in FIG. 12, the exclusive control based on the different exclusive control method for the same shared memory domain “Sm” is ineffective. Therefore, the exclusion acquisition module 142 of the HTM method of the thread “th” which is going to acquire the exclusion waits by execution of the exclusion acquisition processing based on the HTM method till the thread “th” during the exclusion acquisition releases the exclusion based on the lock method.

S22: When the lock based on the lock method has been released or when the exclusion is released based on the lock method (Yes of S21), the exclusion acquisition module 141 executes a start instruction of the HTM 200 and carries out the pre-processing of the HTM method. The pre-processing of the HTM method is mentioned above in FIG. 2 and FIG. 3.

FIG. 18B is a diagram of flow chart indicating the flow of the processing of the exclusion release module 152 of the HTM method.

S31: The exclusion release module 152 of the HTM method executes an end instruction of HTM 200 and performs the post-processing of the HTM method. The post-processing of the HTM method is mentioned above in FIG. 2 and FIG. 3. In this way, the access processing (processing of critical section) to shared memory domain “Sm” performs a decision (completion).

[Processing of Lock Method]

FIG. 19A and FIG. 19B are diagrams of flow charts explaining flows of the processing of exclusion acquisition module 143 of the lock method and exclusion release module 153 of the lock method.

FIG. 19A is a diagram of a flow chart indicating the flow of the processing of the exclusion acquisition module 143 of the lock method (S14 of FIG. 11).

S41: The exclusion acquisition module 143 of the lock method judges whether or not the lock based on the lock method is released. The exclusion acquisition module 143 of the lock method judges whether or not the lock is released based on whether or not a value of the lock variable “spinlock” 160 (FIG. 16, FIG. 17) indicates the lock state.

S42: When the lock based on the lock method has been released or when the exclusion is released based on the lock method (Yes of S41), the exclusion acquisition module 141 acquires the lock. In other words, the exclusion acquisition module 141 updates a value of the lock variable 160 in the value indicating the lock state from the value indicating the non-lock state.

FIG. 19B is a diagram of flow chart indicating the flow of the processing of the exclusion release module 153 of the lock method (S19 of FIG. 11).

S51: The exclusion release module 153 of the lock method releases the lock. In other words, the exclusion release module 153 of the lock method updates a value of the lock variable 160 in the value indicating the non-lock state from the value indicating the lock state.

### Other Embodiment

The embodiment mentioned above exemplified the case that the operation system 131 has the exclusive control program 133 according to the embodiment. But the embodiment is not limited to this example. The application program 132 may include the exclusive control program 133 according to the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a storage unit having a shared memory area; and
a processing unit which carries out one or more threads, and
wherein the processing unit
judges whether or not a plurality of threads, which access the shared memory area, is carried out when executing an access processing to the shared memory area by the thread,
carries out the access processing to the shared memory area based on a first exclusive control which waits a start of the access processing to the shared memory area by another thread during an execution of the access processing to the shared memory area by one thread, when judging that single thread among the plurality of threads is carried out, and
carries out the access processing to the shared memory area based on a second exclusive control which cancels the access processing by one thread in case that a write for the shared memory area by another thread occurs during an execution of the access processing to the shared memory area by one thread, when judging that the plurality of threads are carried out.

2. The information processing device according to claim 1, wherein the processing unit, when starting the execution of new thread and changing a state that the plurality of threads is carried out during that the single thread is carried out, waits the start of the access processing to the shared memory area based on the second exclusive control by the new thread until the access processing based on the first exclusive control finishes.

3. The information processing device according to claim 1, wherein the second exclusive control makes the access processing complete, in case that the write for the shared memory area by another thread does not occur during the execution of the access processing to the shared memory area by one thread.

4. The information processing device according to claim 1, wherein the processing unit, when the execution of any one of the plurality of threads finished and a state transitions to the state that the single thread is carried out, carries out an end processing based on the second exclusive control at an end of the access processing to the shared memory area.

5. The information processing device according to claim 1, wherein the first exclusive control locks the start of the access processing to the shared memory area by another thread during the execution of the access processing to the shared memory area by one thread, and
the second exclusive control detects the write for the shared memory area by another thread among the plurality of threads which is executed in parallel and cancels the access processing by one thread among the plurality of threads in case that the write for the shared memory area by another thread among the plurality of threads detected.

6. A non-transitory computer readable storage medium storing therein a parallel processing program for causing a computer to execute a process, the process comprising:
judging whether or not a plurality of threads, which access a shared memory area, is carried out when executing an access processing to the shared memory area by the thread;
first carrying out the access processing to the shared memory area based on a first exclusive control which waits a start of the access processing to the shared memory area by another thread among the plurality of threads during an execution of the access processing to the shared memory area by one thread among the plurality of threads, when judging that single thread among the plurality of threads is carried out; and
second carrying out the access processing to the shared memory area based on a second exclusive control which cancels the access processing by one thread in case that a write for the shared memory area by another thread occurs during an execution of the access processing to the shared memory area by one thread, when judging that the plurality of threads are carried out.

7. The non-transitory computer readable storage medium according to claim 6, wherein the process further comprises:
waiting, when starting the execution of new thread and changing a state that the plurality of threads is carried out during that the single thread is carried out, the start of the access processing to the shared memory area based on the second exclusive control by the new thread until the access processing based on the first exclusive control finishes.

8. The non-transitory computer readable storage medium according to claim 6, wherein the second carrying out further comprises:
completing the access processing, in case that the write for the shared memory area by another thread does not occur during the execution of the access processing to the shared memory area by one thread.

9. The non-transitory computer readable storage medium according to claim 6, wherein the process further comprises:
executing, when the execution of any one of the plurality of threads finished and a state transitions to the state that the single thread is carried out, an end processing based on the second exclusive control at an end of the access processing to the shared memory area.

10. The non-transitory computer readable storage medium according to claim 6, wherein the first exclusive control locks the start of the access processing to the shared memory area by another thread during the execution of the access processing to the shared memory area by one thread, and
the second exclusive control detects the write for the shared memory area by another thread among the plurality of threads which is executed in parallel and cancels the access processing by one thread among the plurality of threads in case that the write for the shared memory area by another thread among the plurality of threads detected.

11. A method for accessing a shared memory, the method comprising:
judging whether or not a plurality of threads, which access a shared memory area, is carried out when executing an access processing to the shared memory area by the thread;
first carrying out the access processing to the shared memory area based on a first exclusive control which waits a start of the access processing to the shared memory area by another thread among the plurality of threads during an execution of the access processing to the shared memory area by one thread among the plurality of threads, when judging that single thread among the plurality of threads is carried out; and
second carrying out the access processing to the shared memory area based on a second exclusive control which cancels the access processing by one thread in case that a write for the shared memory area by another thread occurs during an execution of the access processing to the shared memory area by one thread, when judging that the plurality of threads are carried out.

12. The method according to claim 11, wherein the method further comprises:
waiting, when starting the execution of new thread and changing a state that the plurality of threads is carried out during that the single thread is carried out, the start of the access processing to the shared memory area based on the second exclusive control by the new thread until the access processing based on the first exclusive control finishes.

13. The method according to claim 11, wherein the second carrying out further comprises:
completing the access processing, in case that the write for the shared memory area by another thread does not occur during the execution of the access processing to the shared memory area by one thread.

14. The method according to claim 11, wherein the method further comprises:
executing, when the execution of any one of the plurality of threads finished and a state transitions to the state that the single thread is carried out, an end processing based on the second exclusive control at an end of the access processing to the shared memory area.

15. The method according to claim 11, wherein the first exclusive control locks the start of the access processing to the shared memory area by another thread during the execution of the access processing to the shared memory area by one thread, and
the second exclusive control detects the write for the shared memory area by another thread among the plurality of threads which is executed in parallel and cancels the access processing by one thread among the plurality of threads in case that the write for the shared memory area by another thread among the plurality of threads detected.
